(19) United States
(12) Patent Application Publication
(10) Pub. No.: US 2024/0010369 A1
(43) Pub. Date: Jan. 11, 2024

(54) AUTONOMOUS STATION FOR PROVIDING ACCOMMODATION OF UNMANNED VEHICLES ON WATER

(71) Applicant: YILDIZ TEKNIK UNIVERSITESI, Istanbul (TR)

(72) Inventors: Mehmet Selcuk ARSLAN, Istanbul (TR); Ahmet KIRLI, Istanbul (TR)

(73) Assignee: YILDIZ TEKNIK UNIVERSITESI, Istanbul (TR)

(21) Appl. No.: 18/025,185

(22) PCT Filed: Nov. 26, 2020
(86) PCT No.: PCT/TR2020/051178

§ 371 Date: Mar. 8, 2023

(30) Foreign Application Priority Data
Sep. 18, 2020 (TR) 2020/14877

(51) Int. Cl. B64U 80/82; B64U 10/13; B63B 35/50

(52) U.S. Cl. CPC B64U 80/82; B64U 10/13; B63B 35/50; B63B 2035/007

(57) ABSTRACT

An autonomous station for providing accommodation of unmanned vehicles like unmanned air vehicles and/or unmanned underwater vehicles on water is provided. Accordingly, the subject matter station includes a floating platform; pluralities of accommodation mechanism for associating said unmanned vehicles provided in said floating platform in order to be charged and fixed; pluralities of movement items for providing movement of the floating platform on water; an energy supply which stores energy for providing electrical energy to said movement items and to the accommodation mechanisms; an energy generation unit for charging said energy supply; a processor unit connected to the movement item in a manner controlling the movement items; a communication unit for providing communication of the processor unit to a main control center.

CROSS REFERENCE TO THE RELATED APPLICATIONS

This application is the national phase entry of International Application No. PCT/TR2020/051178, filed on Nov, 26, 2020, which is based upon and claims priority to Turkish Patent Application No. 2020/14877, filed on Sep. 18, 2020, the entire contents of which are incorporated herein by reference.

### TECHNICAL FIELD

The present invention relates to a station which provides accommodation of unmanned vehicles on water.

### BACKGROUND

Vehicles like unmanned air vehicles (UAV), unmanned underwater vehicles can be used on water or under water with various purposes. These can be various purposes like making site survey on water, making audits on water, making search-rescue activities, making site survey under water, making measurements, taking samples.

The abovementioned vehicles have a battery and can be used during the charge duration of this battery. Movement of the UAVs or UUVs from the main base to the task site and realization of their duties and returning back are only possible in duties with delimited scope, range and duration.

In addition to these, UAVs can face with a temporary unfavorable condition and may get damaged when they cannot get back within this duration.

As a result, because of the abovementioned problems, an improvement is required in the related technical field.

### SUMMARY

The present invention relates to a station, for eliminating the abovementioned disadvantages and for bringing new advantages to the related technical field.

An object of the present invention is to provide a system which provides carrying of unmanned air vehicles to far distances on water.

In order to realize the abovementioned objects and the objects which are to be deducted from the detailed description below, the present invention is an autonomous station for providing accommodation of unmanned vehicles like unmanned air vehicles and/or unmanned underwater vehicles on water. Accordingly, the improvement is that the subject matter station includes a floating platform; pluralities of accommodation mechanism for associating said unmanned vehicles provided in said floating platform in order to be charged and fixed; pluralities of movement items for providing movement of the floating platform on water; an energy supply which stores energy for providing electrical energy to said movement items and to the accommodation mechanisms; an energy generation unit for charging said energy supply; a processor unit connected to the movement item in a manner controlling the movement items; a communication unit for providing communication of the processor unit to a main control center. Thus, the unmanned vehicles are charged on the floating platform and can be carried to far distances on water.

In a possible embodiment of the present invention, at least one of said accommodation mechanisms includes a carrying plate whereon the unmanned air vehicles are positioned; and a balance mechanism is provided which is associated with said carrying plate in order to provide control for fixing the orientation of the carrying plate horizontally. Thus, the unmanned vehicles are positioned on the accommodation mechanism in a balanced manner.

In another possible embodiment of the present invention, at least one of the accommodation mechanisms is positioned at the part of the floating platform which is under water. Thus, unmanned underwater vehicles are positioned at the lower part of the floating platform.

In another possible embodiment of the present invention, the processor unit is configured to communicate also with the unmanned vehicles by means of the communication unit. Thus, the charge condition of the unmanned vehicles is determined and positioning of the unmanned vehicles to the accommodation mechanism is provided in cases where charging is required.

In another possible embodiment of the present invention, the energy generation unit includes pluralities of solar panels.

In another possible embodiment of the present invention, the energy generation unit includes pluralities of wave generators.

In another possible embodiment of the present invention, a cover mechanism is provided which is defined at the floating platform and provided in an openable and closeable manner for at least partially closing an opening of a carrying volume, wherein the accommodation mechanisms are positioned, which is opened to the outer medium and controlled by the processor unit. Thus, the floating platform can be protected from external effects.

In another possible embodiment of the present invention, the energy generation unit includes pluralities of solar panels, and at least one of the solar panels is positioned on the cover mechanism.

In another possible embodiment of the present invention, at least one of the solar panels is positioned on a face of the cover provided at the cover mechanism and at least one other of the solar panels is positioned on another face of the cover provided at the cover mechanism.

In another possible embodiment of the present invention, a sensor unit is provided which is associated with the processor unit. Thus, data is collected through the floating platform and from the unmanned vehicles.

In another possible embodiment of the present invention, the processor unit is configured to control the movement items in accordance with the measurements received from the sensor unit.

In another possible embodiment of the present invention, the sensor unit includes a position module which detects the global position of the station.

In another possible embodiment of the present invention, the main control center includes a storage unit wherein the data received from the processor unit is stored. Thus, the data are stored and the past data can be accessed when required.

In another possible embodiment of the present invention, central management software is provided which is formed by the command lines executed by the processor unit and which provides management of the energy need and usage of the processor unit, electrical storage management, movement control, control of the accommodation mechanism, communication management, data collection and recording management, realization of safety management and healthy operation of all components.

In another possible embodiment of the present invention, said energy supply includes a battery which provides storage of the energy generated in the energy generation unit.

In another possible embodiment of the present invention, charging units are provided which are connected to the battery in order to charge the unmanned vehicles of the accommodation mechanisms.

In another possible embodiment of the present invention, the sensor unit includes at least one of a camera, a GPS module, an IMU and pluralities of sensors.

In another possible embodiment of the present invention, a super capacitor is provided which provides storage of the energy, generated by the energy generation unit, before said energy is transferred to the battery.

### BRIEF DESCRIPTION OF THE DRAWINGS

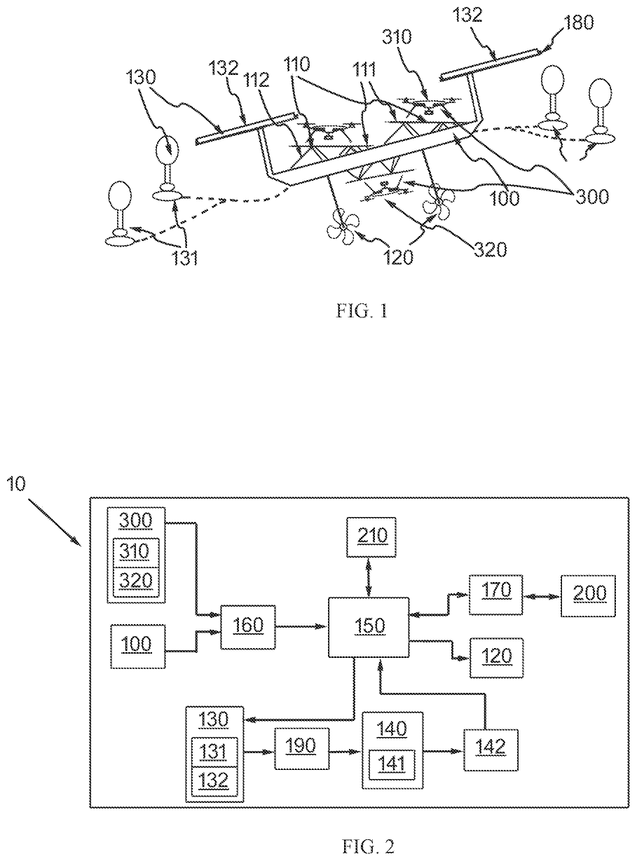

In FIG. 1, a representative view of the station is given.

In FIG. 2, a representative view of the operation scenario of the station is given.

### Reference numbers

10 Station
100 Floating platform
   110 Accommodation mechanism
   111 Carrying plate
   112 Balance mechanism
   120 Movement item
   130 Energy generation unit
      131 Wave generator
      132 Solar panel
   140 Energy supply
      141 Battery
      142 Charging units
   150 Processor unit
   160 Sensor unit
   170 Communication unit
   180 Cover mechanism
   190 Super capacitor
200 Main control center
   210 Storage unit
300 Unmanned vehicle
   310 Unmanned air vehicle
   320 Unmanned underwater vehicle

### DETAILED DESCRIPTION OF THE EMBODIMENTS

In this detailed description, the subject matter is explained with references to examples without forming any restrictive effect only in order to make the subject more understandable.

The present invention relates to an autonomous station (10) for providing accommodation of unmanned vehicles (300) like unmanned air vehicles (310) and/or unmanned underwater vehicles (320) on water. Said station (10) includes a system embodied to provide carrying of the unmanned vehicles (300) to far distances.

Said station (10) includes a platform (100) which floats on water. There are pluralities of accommodation mechanisms (110) for providing association for charging and fixing of said unmanned vehicles (300) provided on said floating platform (100). At least one of said accommodation mechanisms (110) is placed to the part of the floating platform (100) which is above water for positioning of the unmanned air vehicles (310), and at least one of the accommodation mechanisms (110) is placed to the part of the floating platform (100) which is under water for positioning of the unmanned underwater vehicles (320). At least one of the accommodation mechanisms (110) includes a carrying plate (111) for positioning the unmanned vehicles (300) thereon. For providing control in order to fix the orientation of said carrying plate (111) horizontally, there is a balance mechanism (112) associated with the carrying plate (111).

Pluralities of movement items (120) are provided under the floating platform (100) in order to provide movement of the floating platform (100) on water. In a possible embodiment of the present invention, the movement item (120) can be a propeller, motor, motor driver circuit, etc. There is an energy supply (140) which stores energy for providing electrical energy to said movement items (120) and to the accommodation mechanisms (110). An energy generation unit (130) is provided for charging said energy supply (140). As said energy generation unit (130), there are pluralities of solar panels (132) which provide transformation of solar energy into electrical energy. As said energy generation unit (130), there are pluralities of wave generators (131) which provide transformation of movement energy, generated from wave, into electrical energy and connected to the floating platform (100). The energy supply (140) includes a battery (141) which provides storage of the energy generated in the energy generation unit (130). There are charging units (142) connected to said battery (141) in order for said accommodation mechanisms (110) to charge the unmanned vehicles (300). Moreover, there is a super capacitor (190) which provides storing of the energy, generated by the energy generation unit (130), before said energy is transferred to the battery (141).

There is a processor unit (150) associated with the movement items (120) and which control the movement items (120) embodied to provide movement of said floating platform (100). The station (10) includes a communication unit (170) for providing communication of said processor unit (150) with a main control center (200). Said communication unit (170) is moreover configured to provide communication of the processor unit (150) with the unmanned vehicles (300). There is a sensor unit (160) associated with the processor unit (150) for providing controlling of the movement items (120) by means of the processor unit (150) in accordance with the measurement data received from the station (10). Said sensor unit (160) includes at least one of a position module, a camera, an IMU and pluralities of sensors, which detects the global position of the station (10). In a possible embodiment of the present invention, pluralities of used sensors provide measuring of the data related to the station (10) and to the peripheral medium of the station (10) for instance like acceleration, speed and direction determination, determination of weather conditions, energy information, movement information and providing direction information, etc. The main control center (200) has a storage unit (210) wherein the data, received from the processor unit (150), is stored. The station (10) includes central management software formed by command lines executed by the processor unit (150) and which provides management of the energy need and usage of the processor unit (150), electrical storage management, movement control, accommodation mechanism (110) control, communication management, data collection and recording management, realization of safety management and healthy operation of all components.

There is a cover mechanism (180) controlled by a processor unit (150) provided in an openable and closeable manner for at least partially covering an opening of a carrying volume opened to the outer medium wherein the accommodation mechanisms (110) are positioned and defined on the floating platform. Said cover mechanism (180) is embodied to provide protection of the floating platform (100) from external effects like waves, wind, etc. At least one of the solar panels (132) is positioned on a face of the cover provided at the cover mechanism (180) and at least one other of the solar panels (132) is positioned on another face of the cover provided at the cover mechanism (180).

The processor unit is configured to control management of energy need and usage by means of the central management software provided in the processor unit (150), electrical storage management, movement control, accommodation mechanism (110) control, communication management, data collection and recording management, realization of safety management and the control of healthy operation of all components. The processor unit (150) provides realization of data exchange with the main control center (200), provided at the remote section, by means of the communication unit (170). The processor unit (150) provides transfer of information received from the sensor unit (160) like speed, position, direction, weather conditions, energy, charging information, movement information, etc. to the main control center (200). The main control center (200) provides transfer of a signal including the information like landing/taking off, charge, direction, movement, cover control, etc. for guiding the station (10) and the unmanned vehicles (300) to the processor unit (150). Depending on said signal, the processor unit (150) controls and guides the station (10) and the unmanned vehicles (300). The processor unit (150) moreover provides real-time recording of the signals, received from the main control center (200) and collected from the sensors, to the storage unit (210).

In an example operation scenario of the present invention;

The sensor unit (160), provided on the floating platform, provides collection of the data which exists on the station (10) and the data which exists on the unmanned air vehicles (310) connected to the station (10). The collected data includes the data like speed, position, movement, direction, temperature, wind, etc. The collected data are first of all transferred to the processor unit (150). The processor unit (150) provides recording of the data to the storage unit (210) and provides storage of the data. The processor unit (150) moreover provides transfer of data to the main control center (200) by means of the communication unit (170). The data transferred to the main control center (200) is controlled. At the main control center (200), a signal is formed including information like landing/taking off, direction, movement, charge, speed, etc. for guiding the station (10) and the unmanned vehicles (300). Said signal is transferred from the main control center (200) to the processor unit (150) by means of the communication unit (170). The processor unit (150) provides controlling of the station (10) and the unmanned air vehicles (310) according to the coming signal.

The processor unit provides instantaneous comparison of a position signal coming from the main control center (200) and the position signal received from the position module provided on the floating platform (100). In case the floating platform (100) is outside the predetermined tolerance limits on the coming position information, the propellers are operated for providing the floating platform (100) to be within the determined tolerance limits again. For instance, when it is assumed that the route, formed by the position coming from the main control center (200), is an imaginary straight line, the movement of the floating platform (100) for a determined tolerance distance to both sides of the imaginary line shows that the floating platform (100) is in the correct route. In case the floating platform (100) is outside the determined tolerance distance, it is detected that the floating platform (100) deviates from the route and the propellers are operated for providing the floating platform (100) to be within the determined limits again. This condition provides instantaneous monitoring of the floating platform (100) and provides guidance of the platform to the correct route without moving to a faulty route.

The processor unit (150) can provide access to the charge condition information of the unmanned vehicles (300) by means of the communication unit (170) and provides charging or fixing of the unmanned vehicles (300) in the accommodation mechanism (110) as required. In case an unmanned vehicle (300), which needs charging, is detected, the processor unit (150) provides placement of the unmanned vehicle (300) to the carrying plate (111) provided on a predetermined accommodation mechanism (110) by means of the communication unit (170). The balance mechanisms (112), where the carrying plate (111) is connected, provide placement of the unmanned vehicle (300) to the carrying plate (111) in a balanced manner although the floating platform (100) oscillates in cases of wind, wave movement, etc. Said balance mechanism (112) provides guidance of the accommodation mechanism (110) according to the data received from sensors like gyroscope, acceleration-meter, etc. known in the art. Thus, while the unmanned vehicle (300) is being placed on the accommodation mechanism (110), the unfavorable conditions which may occur due to oscillation of the floating platform (100) are prevented. The unmanned vehicle (300), placed to the carrying plate (111), is charged by means of charging units (142) fed by the battery (141).

The processor unit (150) moreover provides management of the energy supply (140). In case the energy, stored in the battery (141), decreases lower than a predetermined limit, the wave generators (131) are operated. Moreover, energy is stored for the battery (141) by means of solar panels (132) within the day. The wave generators (131) are configured to provide transformation of the movement energy into electrical energy depending on the wave movement when the wave generators (131) are operated, and the solar panels (132) are configured to provide transformation of the solar energy into electrical energy in sunlight and to realize energy production and to provide storage of the generated energy in the battery (141).

In an exemplary embodiment of the present invention, position data is transferred from a central unit to a platform which floats on water where a first unmanned air vehicle (310) and a second unmanned underwater vehicle (320) are connected. The propellers are operated in accordance with the coming position data and the movement of the platform to the determined position is provided. The platform advances in the route formed for the determined position. In case the platform is outside the determined route, the propellers are operated in a manner coming to the route again. During advancing of the platform to the determined position on water, in case it is detected that the charge of the first unmanned air vehicle (310), which monitors the platform through air, has decreased, the first unmanned air vehicle (310) is automatically placed onto the predetermined first position on the platform. In case it is detected that the charge of the second unmanned underwater vehicle (320) has decreased, the second unmanned underwater vehicle (320) is automatically placed to a second position on the platform. The unmanned vehicles (300), placed to the first position and to the second position, are charged in the charging units (142) connected to the determined positions. In case the charging process is completed, the unmanned vehicles (300) are guided to the air and to the water again. Thus, the unmanned vehicles (300) can be used for long distances.

The protection scope of the present invention is set forth in the annexed claims and cannot be restricted to the illustrative disclosures given above, under the detailed description. It is because a person skilled in the relevant art can obviously produce similar embodiments under the light of the foregoing disclosures, without departing from the main principles of the present invention.

What is claimed is:

1. An autonomous station for providing an accommodation of unmanned vehicles comprising unmanned air vehicles and/or unmanned underwater vehicles on water, wherein a subject matter station comprises a floating platform;
a plurality of accommodation mechanisms for associating the unmanned vehicles provided in the floating platform in order to be charged and fixed;
a plurality of movement items for providing a movement of the floating platform on water;
an energy supply, wherein the energy supply stores an energy for providing electrical energy to the plurality of movement items and to the plurality of accommodation mechanisms;
an energy generation unit for charging the energy supply;
a processor unit connected to the movement item in a manner controlling the plurality of movement items;
a communication unit for providing a communication of the processor unit to a main control center.

2. The autonomous station according to claim 1, wherein at least one of the plurality of accommodation mechanisms comprises a carrying plate, wherein the unmanned air vehicles are positioned on the carrying plate; and
a balance mechanism is provided, and the balance mechanism is associated with the carrying plate in order to provide a control for fixing an orientation of the carrying plate horizontally.

3. The autonomous station according to claim 1, wherein at least one of the plurality of accommodation mechanisms is positioned at a part of the floating platform, wherein the at least one of the plurality of accommodation mechanisms is under water.

4. The autonomous station according to claim 1, wherein the processor unit is configured to communicate further with the unmanned vehicles by means of the communication unit.

5. The autonomous station according to claim 1, wherein the energy generation unit comprises a plurality of solar panels.

6. The autonomous station according to claim 1, wherein the energy generation unit comprises a plurality of wave generators.

7. The autonomous station according to claim 2, wherein a cover mechanism is provided, wherein the cover mechanism is defined at the floating platform and provided in an openable and closeable manner for at least partially closing an opening of a carrying volume, wherein the plurality of accommodation mechanisms are positioned, the cover mechanism is opened to the outer medium and controlled by the processor unit.

8. The autonomous station according to claim 7, wherein the energy generation unit comprises a plurality of solar panels, and at least one of the plurality of solar panels is positioned on the cover mechanism.

9. The autonomous station according to claim 8, wherein at least one of the plurality of solar panels is positioned on a first face of a cover provided at the cover mechanism and at least one other of the plurality of solar panels is positioned on a second face of the cover provided at the cover mechanism.

10. The autonomous station according to claim 1, wherein a sensor unit is provided, and the sensor unit is associated with the processor unit.

11. The autonomous station according to claim 10, wherein the processor unit is configured to control the plurality of movement items in accordance with measurements received from the sensor unit.

12. The autonomous station according to claim 10, wherein the sensor unit comprises a position module, wherein the position module detects the global position of the autonomous station.

13. The autonomous station according to claim 1, wherein the main control center comprises a storage unit, wherein data received from the processor unit is stored in the storage unit.

14. The autonomous station according to claim 1, wherein a central management software is provided, wherein the central management software is formed by command lines executed by the processor unit and the central management software provides a management of an energy need and usage of the processor unit, an electrical storage management, a movement control, a control of the accommodation mechanism, a communication management, a data collection and recording management, a realization of a safety management and a healthy operation of all components.

15. The autonomous station according to claim 1, wherein the energy supply comprises a battery, wherein the battery provides a storage of an energy generated in the energy generation unit.

16. The autonomous station according to claim 15, wherein charging units are provided, wherein the charging units are connected to the battery in order to charge the unmanned vehicles of the plurality of accommodation mechanisms.

17. The autonomous station according to claim 10, wherein the sensor unit comprises at least one of a camera, a GPS module, an IMU and a plurality of sensors.

18. The autonomous station according to claim 15, wherein a super capacitor is provided, wherein the super capacitor provides the storage of the energy generated by the energy generation unit before the energy is transferred to the battery.
